(19) United States
(12) Patent Application Publication
(10) Pub. No.: US 2023/0312341 A1
(43) Pub. Date: Oct. 5, 2023

(54) PROCESS FOR RENEWABLE ENERGY FORMATION

(71) Applicants: Montana Renewables, LLC, Indianapolis, IN (US); T.EN Stone & Webster Process Technology, Inc., Houston, TX (US)

(72) Inventors: Bruce A. FLEMING, Indianapolis, IN (US); Michael WOJCIECHOWSKI, Indianapolis, IN (US); Ron COLWELL, Indianapolis, IN (US); Eric SCHULE, Indianapolis, IN (US); Scott FOWLER, Houston, TX (US); Vinay KHURANA, Houston, TX (US); Abhijeet KARNIK, Houston, TX (US); Eric WAGNER, Houston, TX (US)

(21) Appl. No.: 18/130,073

(22) Filed: Apr. 3, 2023

Related U.S. Application Data
(60) Provisional application No. 63/327,114, filed on Apr. 4, 2022.

(51) Int. Cl. C01B 3/48; C01B 3/56

(52) U.S. Cl. CPC C01B 3/48; C01B 3/56; C01B 2203/0233; C01B 2203/0283; C01B 2203/1241; C01B 2203/042

(57) ABSTRACT

A method of generating hydrogen from an offgas includes obtaining the offgas from a renewable diesel unit (RDU). The method further includes inputting the offgas to a steam methane reformer (SMR).

### CROSS-REFERENCE TO RELATED APPLICATIONS

This application claims priority under 35 U.S.C. § 119(e) to U.S. Provisional Application Ser. No. 63/327,114 filed on Apr. 4, 2022, the entire disclosure of which is incorporated herein by reference.

### BACKGROUND AND SUMMARY

The use of biomass such as vegetable oils and animal fats as a renewable resource for the production of fuels is highly desirable for many reasons, including energy security, greenhouse gas reduction, agricultural economics, and the like. In this regard, reconfigurations of operations from producing fossil fuels to producing renewable fuels are currently ongoing. For instance, new plants can be built and refinery plants can be converted for processing biomass into high quality “drop in” renewable fuels such as diesel, naphtha, and sustainable aviation fuel (SAF).

However, biomass feedstocks consume relatively large quantities of hydrogen during processing, relative to conventional petroleum refining, and the catalytic reaction generates substantial exothermic heat release requiring quench and/or product recycle to control. This relatively more intensive processing together with chemical properties of the biomass feedstock also causes a much higher yield of low value byproducts, including for example, water, carbon monoxide, carbon dioxide, methane, ethane, propane, and/or butane. As such, there exists a need to beneficially utilize such byproducts.

The present disclosure provides methods of integrating technologies into a new process in which hydrogen is generated from these low value byproducts. For example, the byproducts can be obtained from a renewable diesel unit (RDU) that is used in converting biomass to renewable fuels and such offgas can then be used to produce hydrogen that is utilized in the production process. For example, the offgas can be inputted to a steam methane reformer (SMR) to produce the hydrogen. Additionally or alternatively, the offgas can be inputted a pre-reformer reactor to produce methane and the methane can then be inputted to a SMR to produce hydrogen.

### BRIEF DESCRIPTION OF THE DRAWINGS

FIG. 1 shows the overall process of converting renewable biomass to renewable fuels.

### DETAILED DESCRIPTION

The following numbered embodiments are contemplated and are non-limiting:
1. A method of generating hydrogen from an offgas, said method comprising the step of obtaining the offgas from a renewable diesel unit (RDU) and inputting the offgas to a steam methane reformer (SMR), wherein the hydrogen is produced via utilization of the SMR.
2. The method of clause 1, any other suitable clause, or any combination of suitable clauses, wherein the hydrogen is renewable hydrogen.
3. The method of clause 1, any other suitable clause, or any combination of suitable clauses, wherein the hydrogen is produced with lower levels of nitrogen oxide (NOx) emissions.
4. The method of clause 3, any other suitable clause, or any combination of suitable clauses, wherein the lower levels of NOx emissions are less than 0.05 lb/MMBtu.
5. The method of clause 3, any other suitable clause, or any combination of suitable clauses, wherein the lower levels of NOx emissions are provided post-selective catalytic reduction (SCR).
6. The method of clause 3, any other suitable clause, or any combination of suitable clauses, wherein the lower levels of NOx emissions are reduced up to an additional 95%.
7. The method of clause 1, any other suitable clause, or any combination of suitable clauses, wherein the offgas is selected from the group consisting of carbon monoxide, carbon dioxide, methane, ethane, propane, butane, hydrogen, and any combination thereof.
8. The method of clause 1, any other suitable clause, or any combination of suitable clauses, wherein the offgas comprises carbon monoxide.
9. The method of clause 1, any other suitable clause, or any combination of suitable clauses, wherein the offgas comprises carbon dioxide.
10. The method of clause 1, any other suitable clause, or any combination of suitable clauses, wherein the offgas comprises methane.
11. The method of clause 1, any other suitable clause, or any combination of suitable clauses, wherein the offgas comprises ethane.
12. The method of clause 1, any other suitable clause, or any combination of suitable clauses, wherein the offgas comprises propane.
13. The method of clause 1, any other suitable clause, or any combination of suitable clauses, wherein the offgas comprises butane.
14. The method of clause 1, any other suitable clause, or any combination of suitable clauses, wherein the SMR comprises a pressure swing adsorption (PSA) process.
15. The method of clause 1, any other suitable clause, or any combination of suitable clauses, wherein the offgas is inputted to the SMR via a compressor.
16. A method of generating hydrogen from an offgas, said method comprising the steps of
   obtaining the offgas from a renewable diesel unit (RDU),
   inputting the offgas to a pre-reformer reactor to produce methane, and
   inputting the methane to a steam methane reformer (SMR), wherein the hydrogen is produced from the methane.
17. The method of clause 16, any other suitable clause, or any combination of suitable clauses, wherein the hydrogen is subsequently inputted to the RDU.
18. The method of clause 16, any other suitable clause, or any combination of suitable clauses, wherein the hydrogen is subsequently inputted to a second RDU.
19. The method of clause 16, any other suitable clause, or any combination of suitable clauses, wherein the hydrogen is renewable hydrogen.
20. The method of clause 16, any other suitable clause, or any combination of suitable clauses, wherein the hydrogen is produced with lower levels of nitrogen oxide (NOx) emissions.
21. The method of clause 20, any other suitable clause, or any combination of suitable clauses, wherein the lower levels of NOx emissions are less than 0.05 lb/MMBtu.
22. The method of clause 20, any other suitable clause, or any combination of suitable clauses, wherein the lower levels of NOx emissions are provided post-selective catalytic reduction (SCR).
23. The method of clause 20, any other suitable clause, or any combination of suitable clauses, wherein the lower levels of NOx emissions are reduced up to an additional 95%.
24. The method of clause 16, any other suitable clause, or any combination of suitable clauses, wherein the offgas is selected from the group consisting of carbon monoxide, carbon dioxide, methane, ethane, propane, butane, hydrogen, and any combination thereof.
25. The method of clause 16, any other suitable clause, or any combination of suitable clauses, wherein the offgas comprises carbon monoxide.
26. The method of clause 16, any other suitable clause, or any combination of suitable clauses, wherein the offgas comprises carbon dioxide.
27. The method of clause 16, any other suitable clause, or any combination of suitable clauses, wherein the offgas comprises methane.
28. The method of clause 16, any other suitable clause, or any combination of suitable clauses, wherein the offgas comprises ethane.
29. The method of clause 16, any other suitable clause, or any combination of suitable clauses, wherein the offgas comprises propane.
30. The method of clause 16, any other suitable clause, or any combination of suitable clauses, wherein the offgas comprises butane.
31. The method of clause 16, any other suitable clause, or any combination of suitable clauses, wherein the offgas is inputted to the pre-reformer reactor via a compressor.
32. The method of clause 16, any other suitable clause, or any combination of suitable clauses, wherein the SMR comprises a pressure swing adsorption (PSA) process.
33. The method of clause 16, any other suitable clause, or any combination of suitable clauses, wherein the method is performed to be substantially free of using natural gas.
34. The method of clause 16, any other suitable clause, or any combination of suitable clauses, wherein the method is performed to be substantially free of using methane from natural gas.
35. A method of providing hydrogen to a renewable diesel unit (RDU), said method comprising the steps of obtaining an offgas from the RDU and converting the offgas to hydrogen, wherein the hydrogen is produced via a steam methane reformer (SMR), and subsequently providing the hydrogen to the RDU.
36. The method of clause 35, any other suitable clause, or any combination of suitable clauses, wherein the conversion of offgas to hydrogen comprises a step of inputting the offgas to a pre-reformer reactor to produce methane.
37. The method of clause 36, any other suitable clause, or any combination of suitable clauses, wherein the methane is inputted to the SMR, and wherein the hydrogen is produced from the methane.
38. The method of clause 35, any other suitable clause, or any combination of suitable clauses, wherein the hydrogen is renewable hydrogen.
39. The method of clause 35, any other suitable clause, or any combination of suitable clauses, wherein the hydrogen is produced with lower levels of nitrogen oxide (NOx) emissions.
40. The method of clause 39, any other suitable clause, or any combination of suitable clauses, wherein the lower levels of NOx emissions are less than 0.05 lb/MMBtu.
41. The method of clause 39, any other suitable clause, or any combination of suitable clauses, wherein the lower levels of NOx emissions are provided post-selective catalytic reduction (SCR).
42. The method of clause 39, any other suitable clause, or any combination of suitable clauses, wherein the lower levels of NOx emissions are reduced up to an additional 95%.
43. The method of clause 35, any other suitable clause, or any combination of suitable clauses, wherein the offgas is selected from the group consisting of carbon monoxide, carbon dioxide, methane, ethane, propane, butane, hydrogen, and any combination thereof.
44. The method of clause 35, any other suitable clause, or any combination of suitable clauses, wherein the offgas comprises carbon monoxide.
45. The method of clause 35, any other suitable clause, or any combination of suitable clauses, wherein the offgas comprises carbon dioxide.
46. The method of clause 35, any other suitable clause, or any combination of suitable clauses, wherein the offgas comprises methane.
47. The method of clause 35, any other suitable clause, or any combination of suitable clauses, wherein the offgas comprises ethane.
48. The method of clause 35, any other suitable clause, or any combination of suitable clauses, wherein the offgas comprises propane.
49. The method of clause 35, any other suitable clause, or any combination of suitable clauses, wherein the offgas comprises butane.
50. The method of clause 35, any other suitable clause, or any combination of suitable clauses, wherein the SMR comprises a pressure swing adsorption (PSA) process.
51. The method of clause 35, any other suitable clause, or any combination of suitable clauses, wherein the offgas is inputted to the SMR via a compressor.

In an illustrative aspect, a method of generating hydrogen from an offgas is provided. The method comprises the step of obtaining the offgas from a renewable diesel unit (RDU) and inputting the offgas to a steam methane reformer (SMR), wherein the hydrogen is produced via utilization of the SMR.

In an embodiment, the hydrogen is renewable hydrogen. In an embodiment, the hydrogen is produced with lower levels of nitrogen oxide (NOx) emissions. In an embodiment, the lower levels of NOx emissions are less than 0.05 lb/MMBtu. In an embodiment, the lower levels of NOx emissions are provided post-selective catalytic reduction (SCR). In an embodiment, the lower levels of NOx emissions are reduced up to an additional 95%.

In an embodiment, the offgas is selected from the group consisting of carbon monoxide, carbon dioxide, methane, ethane, propane, butane, hydrogen, and any combination thereof. In an embodiment, the offgas comprises carbon monoxide. In an embodiment, the offgas comprises carbon dioxide. In an embodiment, the offgas comprises methane. In an embodiment, the offgas comprises ethane. In an embodiment, the offgas comprises propane. In an embodiment, the offgas comprises butane.

In an embodiment, the SMR comprises a pressure swing adsorption (PSA) process. In an embodiment, the offgas is inputted to the SMR via a compressor.

In an illustrative aspect, a method of generating hydrogen from an offgas is provided. The method comprises the steps of obtaining the offgas from a renewable diesel unit (RDU), inputting the offgas to a pre-reformer reactor to produce methane, and inputting the methane to a steam methane reformer (SMR), wherein the hydrogen is produced from the methane.

In an embodiment, the hydrogen is subsequently inputted to the RDU. In an embodiment, the hydrogen is subsequently inputted to a second RDU.

In an embodiment, the hydrogen is renewable hydrogen. In an embodiment, the hydrogen is produced with lower levels of nitrogen oxide (NOx) emissions. In an embodiment, the lower levels of NOx emissions are less than 0.05 lb/MMBtu. In an embodiment, the lower levels of NOx emissions are provided post-selective catalytic reduction (SCR). In an embodiment, the lower levels of NOx emissions are reduced up to an additional 95%.

In an embodiment, the offgas is selected from the group consisting of carbon monoxide, carbon dioxide, methane, ethane, propane, butane, hydrogen, and any combination thereof. In an embodiment, the offgas comprises carbon monoxide. In an embodiment, the offgas comprises carbon dioxide. In an embodiment, the offgas comprises methane. In an embodiment, the offgas comprises ethane. In an embodiment, the offgas comprises propane. In an embodiment, the offgas comprises butane.

In an embodiment, the offgas is inputted to the pre-reformer reactor via a compressor. In an embodiment, the SMR comprises a pressure swing adsorption (PSA) process.

In an embodiment, the method is performed to be substantially free of using natural gas. In an embodiment, the method is performed to be substantially free of using methane from natural gas.

In an illustrative aspect, a method of providing hydrogen to a renewable diesel unit (RDU) is provide. The method comprises the steps of obtaining an offgas from the RDU and converting the offgas to hydrogen, wherein the hydrogen is produced via a steam methane reformer (SMR), and subsequently providing the hydrogen to the RDU.

In an embodiment, the conversion of offgas to hydrogen comprises a step of inputting the offgas to a pre-reformer reactor to produce methane. In an embodiment, the methane is inputted to the SMR, and wherein the hydrogen is produced from the methane.

In an embodiment, the hydrogen is renewable hydrogen. In an embodiment, the hydrogen is produced with lower levels of nitrogen oxide (NOx) emissions. In an embodiment, the lower levels of NOx emissions are less than 0.05 lb/MMBtu. In an embodiment, the lower levels of NOx emissions are provided post-selective catalytic reduction (SCR). In an embodiment, the lower levels of NOx emissions are reduced up to an additional 95%.

In an embodiment, the offgas is selected from the group consisting of carbon monoxide, carbon dioxide, methane, ethane, propane, butane, hydrogen, and any combination thereof. In an embodiment, the offgas comprises carbon monoxide. In an embodiment, the offgas comprises carbon dioxide. In an embodiment, the offgas comprises methane. In an embodiment, the offgas comprises ethane. In an embodiment, the offgas comprises propane. In an embodiment, the offgas comprises butane.

In an embodiment, the SMR comprises a pressure swing adsorption (PSA) process. In an embodiment, the offgas is inputted to the SMR via a compressor.

In an embodiment, CO₂ produced in the SMR and the water gas shift reactor(s) can be captured from the syngas thereby resulting in a negative carbon footprint.

In an embodiment, CO₂ can be captured from the SMR flue gas resulting in a negative carbon footprint.

In an embodiment, CO₂ can be captured from the PSA purge gas resulting in a negative carbon footprint.

In an embodiment, the CO₂, either individually or collectively, is collected, compressed and transported for use as a chemical feedstock or sequestered.

In an embodiment, the SMR is provided fuel by renewable hydrogen.

### Example

Advantageously, the hydrogen produced from the undesirable offgasses can be subsequently inputted back to an RDU as part of the overall production process of renewable fuels such as renewable naphtha, renewable aviation fuel, and/or renewable diesel. Generating a “green” renewable hydrogen in this manner can desirably reduce or even eliminate the need for natural gas that is typically used for hydrogen production. In turn, this beneficially reduces the carbon footprint of the overall renewable diesel process, depending upon the amount of offgases being generated. The methods of the present disclosure provide a novel mechanism for efficient modification and utilization of standard SMR hydrogen plant technologies. In addition, the methods of the present disclosure can produce lower levels of nitrogen oxide (NOx) emissions to meet ultra-low NOx emissions standards and thus reduce the need of additional environmental controls. It is contemplated that the design can eventually reduce NOx by up to an additional 95%, for example via selective catalytic reduction (SCR) provisions. For instance, this can be part of the CO₂ capture ready design, as NOx emissions tend to increase once the ‘inert’ CO₂ (inert to the combustion process) is removed from the purge gas.

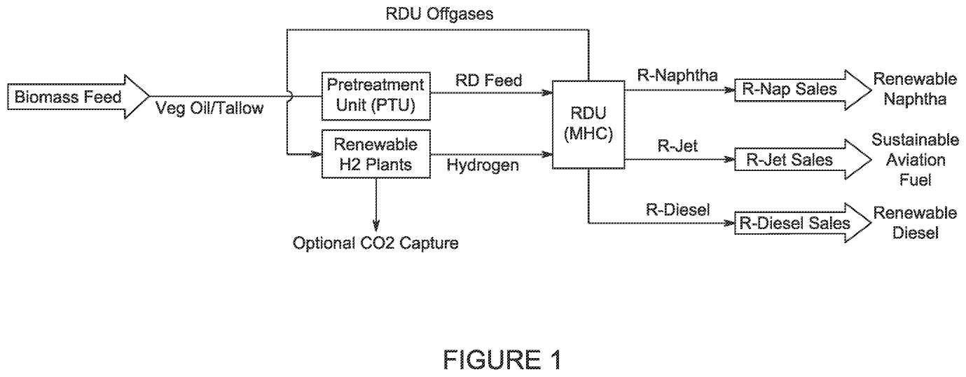

The overall process of converting renewable biomass to renewable fuels is presented in FIG. 1. The process utilizes biomass (e.g., oils from seed oils, rendered tallows, and others) as feedstock for the renewable fuel production process. Generally, the raw feedstock may contain a variety of poisonous contaminants or foulants for the catalyst system utilized in the RDU. As such, the feedstock is typically cleaned in a pretreatment unit (PTU) that hydrolyzes phospholipids and removes metals and other inorganic contaminants.

The feedstock is then inputted to the RDU, in which a hydrogen-rich catalytic hydroprocessing operation converts the feedstock to renewable fuel. In an embodiment, the RDU can comprise a single reactor with multiple fixed catalyst beds. In the first beds of the reactor, the feed oil can be converted to renewable fuel (e.g., diesel, aviation, and/or naphtha) through various reactions. The latter bed(s) of the reactor provide a catalyst designed for isomerization of the renewable products for the purpose of improving renewable fuel cold-flow properties. Importantly, the conversion reactions require the consumption of hydrogen.

The net result of the process is conversion of biomass into renewable fuels (e.g., diesel, aviation, and naphtha). However, as described previously, the process also creates low value side products in the form of offgases comprising carbon monoxide, carbon dioxide, methane, ethane, propane, and/or butane.

Typically, the supply of hydrogen utilized for the RDU process comes from hydrogen plants that use a steam methane reforming (SMR) process which converts methane to hydrogen and carbon dioxide. The methane is generally supplied as natural gas from public utility companies.

However, according to the present disclosure, the hydrogen supply for the RDU can beneficially be produced from the renewable byproducts produced during biomass conversion to fuels. The offgases are provided from the RDU and then routed through a compressor to feed the hydrogen plants in which hydrocarbon molecules heavier than methane (e.g., ethane, propane, and butane) are first converted to methane in a prereformer reactor. As a result, the offgasses provide an alternative fully renewable biomass derived hydrogen in the process of producing renewable fuels.

1. A method of generating hydrogen from an offgas, said method comprising the step of obtaining the offgas from a renewable diesel unit (RDU) and inputting the offgas to a steam methane reformer (SMR), wherein the hydrogen is produced via utilization of the SMR.

2. The method of claim 1, wherein the hydrogen is renewable hydrogen.

3. The method of claim 1, wherein the hydrogen is produced with lower levels of nitrogen oxide (NOx) emissions.

4. The method of claim 3, wherein the lower levels of NOx emissions are less than 0.05 lb/MMBtu.

5. The method of claim 3, wherein the lower levels of NOx emissions are provided post-selective catalytic reduction (SCR).

6. The method of claim 3, wherein the lower levels of NOx emissions are reduced up to an additional 95%.

7. The method of claim 1, wherein the offgas is selected from the group consisting of carbon monoxide, carbon dioxide, methane, ethane, propane, butane, hydrogen, and any combination thereof.

8. The method of claim 1, wherein the SMR comprises a pressure swing adsorption (PSA) process.

9. The method of claim 1, wherein the offgas is inputted to the SMR via a compressor.

10. A method of generating hydrogen from an offgas, said method comprising the steps of
obtaining the offgas from a renewable diesel unit (RDU),
inputting the offgas to a pre-reformer reactor to produce methane, and
inputting the methane to a steam methane reformer (SMR), wherein the hydrogen is produced from the methane.

11. The method of claim 10, wherein the hydrogen is subsequently inputted to the RDU.

12. The method of claim 10, wherein the hydrogen is subsequently inputted to a second RDU.

13. The method of claim 10, wherein the hydrogen is renewable hydrogen.

14. The method of claim 10, wherein the hydrogen is produced with lower levels of nitrogen oxide (NOx) emissions.

15. The method of claim 10, wherein the offgas is selected from the group consisting of carbon monoxide, carbon dioxide, methane, ethane, propane, butane, hydrogen, and any combination thereof.

16. The method of claim 10, wherein the method is performed to be substantially free of using methane from natural gas.

17. The method of claim 1, wherein the CO₂ produced in the SMR and the water gas shift reactor(s) is captured from the syngas.

18. The method of claim 1, wherein CO₂ is captured from the SMR flue gas.

19. The method of claim 1, wherein CO₂ is captured from the PSA purge gas.

20. The method of claim 1, wherein the SMR is provided fuel by renewable hydrogen.
